(19) United States
(12) Patent Application Publication
(10) Pub. No.: US 2026/0143227 A1
(43) Pub. Date: May 21, 2026

(54) IMAGE CAPTURE CONTROL APPARATUS, IMAGE CAPTURE CONTROL METHOD, IMAGE CAPTURE APPARATUS, AND IMAGE CAPTURE SYSTEM

(71) Applicant: CANON KABUSHIKI KAISHA, Tokyo (JP)

(72) Inventor: TAKASHI SUGIMOTO, Kanagawa (JP)

(21) Appl. No.: 19/416,309

(22) Filed: Dec. 11, 2025

Related U.S. Application Data
(63) Continuation of application No. PCT/JP2024/022128, filed on Jun. 18, 2024.

(30) Foreign Application Priority Data
Jun. 29, 2023 (JP) 2023-107223

(51) Int. Cl. H04N 23/661; H04N 23/63; H04N 23/90

(52) U.S. Cl. CPC H04N 23/661; H04N 23/631; H04N 23/90

(57) ABSTRACT

An image capture control device and an image capture control method that improve the ease of use in configuring a setting of image capture apparatuses to be controlled are disclosed. The image capture control apparatus is capable of remotely operating an image capture apparatus. The image capture control apparatus generates a setting command specifying a detail to be set in common for a plurality of image capture apparatuses. The image capture control apparatus then transmits the setting command to the plurality of image capture apparatuses.

### CROSS-REFERENCE TO RELATED APPLICATIONS

This application is a Continuation of International Patent Application No. PCT/JP2024/022128, filed Jun. 18, 2024, which claims the benefit of Japanese Patent Application No. 2023-107223, filed on Jun. 29, 2023, both of which are hereby incorporated by reference herein in their entirety.

### BACKGROUND

### Field of the Technology

The present disclosure relates to an image capture control apparatus, an image capture control method, an image capture apparatus, and an image capture system.

### Description of the Related Art

An image capture system is known in which a plurality of image capture apparatuses are remotely controlled from one control device (“NX Field Quick Setup Guide” [online], 2022, Nikon Corporation, [retrieved Jun. 19, 2023], Internet <URL: https://nps.nikonimaging.com/technical_info/nx_field/pdf/NXFieldQSG_Jp.pdf>). According to such an image capture system, image capture using a plurality of image capture apparatuses can be easily achieved by one person.

In conventional image capture systems, even when configuring settings that are to be held in common by two or more image capture apparatuses, the settings need to be made for each apparatus individually from the control device. For this reason, if there are many image capture apparatuses to be remotely controlled, changing the settings is time-consuming.

### SUMMARY

In one embodiment, the present disclosure provides an image capture control device and an image capture control method that improve the ease of use in configuring a setting of image capture apparatuses to be controlled.

In one aspect, the present disclosure provides an image capture control apparatus capable of remotely operating an image capture apparatus, the image capture control apparatus being characterized by including generation means for generating a setting command specifying a detail to be set in common for a plurality of image capture apparatuses, and transmission means for transmitting the setting command to the plurality of image capture apparatuses.

Features of the present disclosure will become apparent from the following description of embodiments with reference to the attached drawings.

### BRIEF DESCRIPTION OF THE DRAWINGS

FIG. 1A is a block diagram showing an example of a functional configuration of a digital camera serving as an image capture apparatus according to an embodiment.

FIG. 1B is a diagram showing an example of an external appearance of a digital camera serving as an image capture apparatus according to an embodiment.

FIG. 1C is a diagram showing an example of an external appearance of a digital camera serving as an image capture apparatus according to an embodiment.

FIG. 2 is a block diagram showing an example of a functional configuration of a smartphone serving as an image capture control apparatus according to an embodiment.

FIG. 3 is a schematic diagram showing an example of a configuration of a remote image capture system according to an embodiment.

FIG. 4 is a schematic diagram showing an example of use of a remote image capture system according to an embodiment.

FIG. 5A is a diagram showing an example of a screen of a remote image capture application executed by a smartphone according to an embodiment.

FIG. 5B is a diagram showing an example of a screen of a remote image capture application executed by a smartphone according to an embodiment.

FIG. 6 is a flowchart showing operation of a smartphone according to an embodiment.

FIG. 7 is a flowchart showing operation of a smartphone according to an embodiment.

FIG. 8A is a diagram showing an example of a screen of a remote image capture application executed by a smartphone according to an embodiment.

FIG. 8B is a diagram showing an example of a screen of a remote image capture application executed by a smartphone according to an embodiment.

FIG. 9A is a diagram showing an example of a screen of a remote image capture application executed by a smartphone according to an embodiment.

FIG. 9B is a diagram showing an example of a screen of a remote image capture application executed by a smartphone according to an embodiment.

FIG. 10A is a diagram showing an example of a screen of a remote image capture application executed by a smartphone according to an embodiment.

FIG. 10B is a diagram showing an example of a screen of a remote image capture application executed by a smartphone according to an embodiment.

FIG. 11 is a flowchart showing operation of a digital camera according to an embodiment.

### DESCRIPTION OF THE EMBODIMENTS

Hereinafter, the present disclosure will be described in detail based on exemplary embodiments thereof, with reference to the accompanying drawings. It should be noted that the following embodiments do not limit the scope of the claims. In addition, although the embodiments describe a plurality of features, not all of them are necessarily essential, and the plurality of features may be combined in any manner. Furthermore, in the accompanying drawings, the same or similar components are denoted by the same reference numerals, and redundant description is omitted.

Note that the following embodiment will describe a case where the embodiment is implemented in a smartphone. However, the embodiment may be implemented in any electronic device that is capable of communicating with a plurality of image capture apparatuses and accepts a user operation. Such electronic devices include image capture apparatuses, computer devices (personal computers, tablet computers, media players, PDAs, etc.), and game consoles. These are merely examples, and the embodiment can be implemented in other electronic devices as well.

### Example of Configuration of Digital Camera

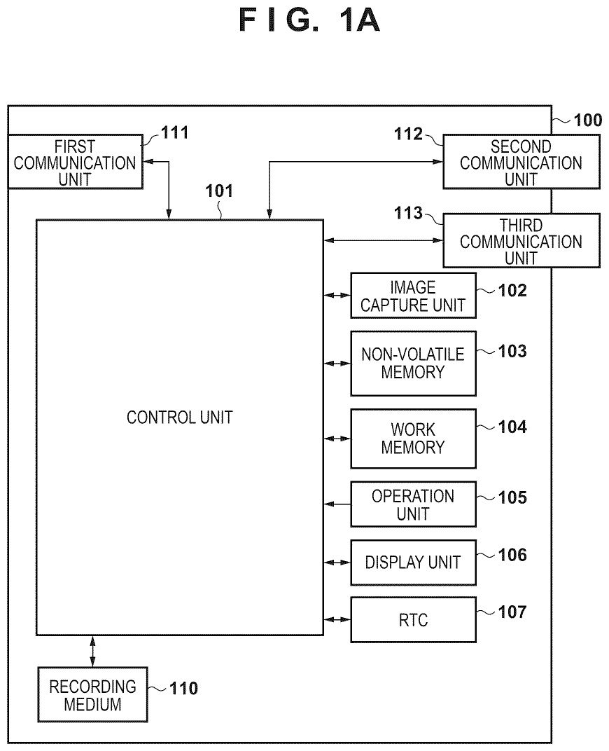

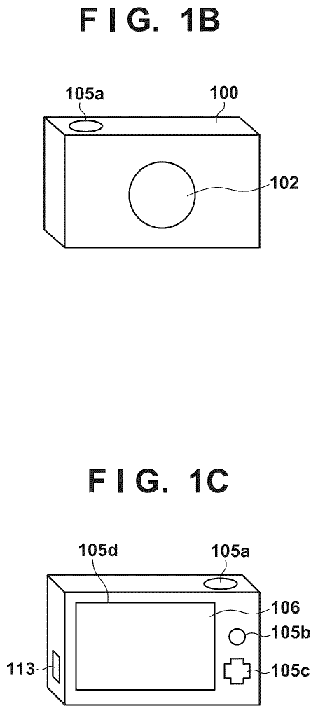

FIG. 1A is a block diagram showing an example of a functional configuration of a digital camera (hereinafter simply referred to as a camera) 100 serving as an image capture apparatus controlled by an image capture control device. Also, FIGS. 1B and 1C are perspective views showing examples of the external appearance of the camera 100. FIG. 1B mainly shows an example of the external appearance on the front side, and FIG. 1C mainly shows an example of the external appearance on the rear side.

A control unit 101 has one or more processors (hereinafter referred to as CPUs) capable of executing a program, and loads a program stored in, for example, a non-volatile memory 103 into a work memory 104 and executes the program. The control unit 101 executes a program to control the operation of each functional block and realize the functions of the camera 100.

The non-volatile memory 103, which may be rewritable, stores programs executable by the CPU of the control unit 101, setting values for the camera 100, GUI data, and the like. The non-volatile memory 103 also stores information about external devices with which communication has been performed.

Note that it is assumed that the operation of the camera 100, which will be described later, is achieved by the CPU of the control unit 101 executing a program stored in the non-volatile memory 103.

The work memory 104 is, for example, a volatile memory, and is used to load the program to be executed by the CPU of the control unit 101 and to store values required during the execution of the program. In addition, a part of the work memory 104 may also be used as a display memory for a display unit 106.

An image capture unit 102 is a camera unit having an image capture optical system, an image sensor, and the like. The image capture unit 102 performs image capture under the control of the control unit 101 and stores obtained image data in the work memory 104. The control unit 101 applies predetermined image processing to the image data to generate an image data file. The control unit 101 records the image data file in a recording medium 110, for example. The control unit 101 also applies predetermined image processing to the image data to generate image data for display. The control unit 101 stores the image data for display in a video memory region of the work memory 104, composites an image showing information such as current setting values, and displays the image on the display unit 106.

While the image capture unit 102 is capturing a moving image, the captured moving image can be immediately displayed on the display unit 106, thereby allowing the display unit 106 to function as an electronic viewfinder (EVF). The moving image that is displayed to cause the display unit 106 to function as an EVF is called a live view image.

An operation unit 105 is a general term for an input device provided in the camera 100. The operation unit 105 may include, but is not limited to, a touch panel 105d provided on the display unit 106, a playback button 105b, a power switch, a release switch 105a, a moving image capture button, a direction key 105c, a setting button, a menu button, and the like. Upon detecting an operation on the operation unit 105, the control unit 101 executes an operation corresponding to the detected operation.

The control unit 101 recognizes a half-pressed state of the release switch 105a as a shooting preparation instruction, and a fully-pressed state as a shooting start instruction. Upon recognizing the shooting preparation instruction, the control unit 101 executes automatic focus detection (AF) processing and automatic exposure control (AE) processing. Upon recognizing the shooting start instruction, the control unit 101 executes still image shooting processing and records a data file storing still image data on the recording medium 110. In addition, when the moving image capture button is pressed in a shooting standby state, the control unit 101 recognizes it as a moving image recording start instruction, and when the button is pressed while recording a moving image, the control unit 101 recognizes it as a recording stop instruction.

The display unit 106 is used to display images captured by the image capture unit 102, images recorded on the recording medium 110, menu screens, and the like. Note that the camera 100 may be connectable to an external display device. In this embodiment, the display unit 106 is a touch display provided with the touch panel 105d.

An RTC 107 has, for example, a calendar function and a timer function, and can be used by the control unit 101. The date and time of the RTC 107 can be set by the user via the operation unit 105, or can be set according to a value acquired via one of a first communication unit 111 to a third communication unit 113, which will be described later.

The recording medium 110 is provided separately from the non-volatile memory 103 and may be, for example, a semiconductor memory card. The recording medium 110 is used as a recording destination for image data files generated by the control unit 101, for example.

The first communication unit 111 to the third communication unit 113 are communication interfaces. The camera 100 can communicate with external devices using the first communication unit 111 to the third communication unit 113. The operations of the first communication unit 111 to the third communication unit 113 are controlled by the control unit 101. The first communication unit 111 to the third communication unit 113 perform communication with external devices conforming to one or more known wired and wireless communication standards. The first communication unit 111 to the third communication unit 113 have circuits (antennas, connectors, transceivers, etc.) corresponding to the communication standards to which they conform.

In this embodiment, as an example, it is assumed that the first communication unit 111 is a wireless communication interface conforming to the standard of wireless LAN (IEEE 802.11 series). Also, it is assumed that the second communication unit 112 is a wireless communication interface conforming to the standard of Bluetooth (registered trademark) version 4.0 or later, particularly Bluetooth Low Energy (BLE). Furthermore, it is assumed that the third communication unit 113 is a wired LAN (Ethernet) interface conforming to the standard of IEEE 802.3. Note that the first communication unit 111 to the third communication unit 113 may conform to other known wired or wireless communication standards. In addition, two or more of the first communication unit 111 to the third communication unit 113 may conform to the same communication standard.

Note that the second communication unit 112 can operate in a peripheral mode or a central mode in the BLE standard. When the second communication unit 112 operates in the peripheral mode, the camera 100 can connect to and communicate with an external device having a communication unit operating in the central mode. In this embodiment, when communicating with a smartphone 200, which is an image capture control apparatus, through a second communication unit 212, the camera 100 functions as a client and transmits image data to the smartphone 200, which functions as a server.

Note that information about paired external devices is stored in the non-volatile memory 103. In addition, even when a power source SW is turned off, the second communication unit 112 can operate in sleep mode, and when an event occurs, the second communication unit 112 can cancel the sleep mode and communicate with an external device.

### Example of Configuration of Smartphone

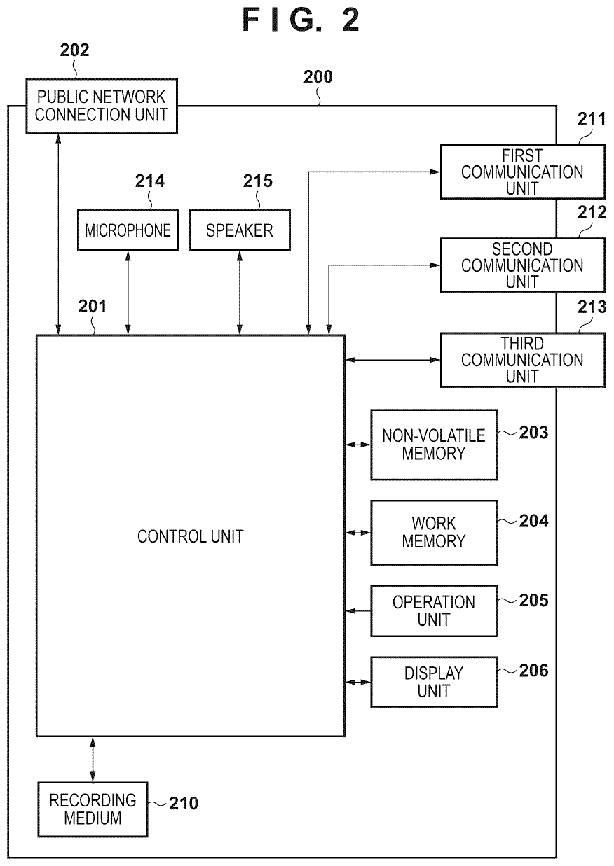

FIG. 2 is a block diagram showing an example of a functional configuration of the smartphone 200 serving as an example of an image capture control apparatus according to the embodiment. As described above, the image capture control apparatus according to this embodiment is not limited to the smartphone 200, and any electronic device capable of communicating with a plurality of cameras 100 can be used.

A control unit 201 has one or more processors (hereinafter referred to as CPUs) capable of executing a program, and loads a program stored in, for example, a non-volatile memory 203 into a work memory 204 and executes the program. The control unit 201 executes a program to control the operation of each functional block and realize the functions of the smartphone 200.

The non-volatile memory 203, which may be rewritable, stores programs (such as an operating system (OS) and applications) that can be executed by the CPU of the control unit 201, setting values for the smartphone 200 and applications, user data, and the like. As will be described later, the smartphone 200 also stores, in the non-volatile memory 203, information about an external device with which communication has been performed and information needed to resume communication with the external device with which communication has been performed.

Note that it is assumed that the operation of the smartphone 200, which will be described later, is realized by executing an application (remote image capture application) stored in the non-volatile memory 203. Note that the remote image capture application can use the functions provided by the OS as appropriate. For example, the OS can provide basic functions related to wireless communication with external devices that conform to a specific wireless communication standard, such as checking the presence or absence of external devices and establishing and disconnecting wireless connections (links) with external devices.

The work memory 204 is, for example, a volatile memory, and is used to load the program to be executed by the CPU of the control unit 201 and to store values required during the execution of the program. In addition, a part of the work memory 204 may be used as a display memory for a display unit 206.

An operation unit 205 is a general term for an input device provided in the smartphone 200. The operation unit 205 may include, but is not limited to, a touch panel provided on the display unit 206, a power switch, a volume adjustment button, and the like. Upon detecting an operation on the operation unit 205, the control unit 201 executes an operation corresponding to the detected operation. For example, upon detecting a tap operation on a displayed application icon, the control unit 201 starts up the application corresponding to the icon or returns the application to an active state.

The display unit 206 is a display device, and is assumed to be a touch display here. The display unit 206 displays a screen provided by the OS or application. Note that the smartphone 200 may be connectable to an external display device.

An RTC 207 has, for example, a calendar function and a timer function, and can be used by the control unit 201. The date and time of the RTC 207 can be set by the user via the operation unit 205, or can be set according to a value acquired via one of a first communication unit 211 to a third communication unit 213, which will be described later.

A recording medium 210 may be, for example, a semiconductor memory card. The recording medium 210 is used as a recording destination for image data files received from, for example, an external device. Note that the recording medium 210 may also be used as a part of the non-volatile memory 203 (to expand the capacity of the non-volatile memory 203).

The first communication unit 211 to the third communication unit 213 are communication interfaces. The smartphone 200 can communicate with external devices using the first communication unit 211 to the third communication unit 213. The operations of the first communication unit 211 to the third communication unit 213 are controlled by the control unit 201. The first communication unit 211 to the third communication unit 213 perform communication with external devices conforming to one or more known wired and wireless communication standards. The first communication unit 211 to the third communication unit 213 have circuits (antennas, connectors, transceivers, etc.) corresponding to the communication standards to which they conform.

In this embodiment, as an example, it is assumed that the first communication unit 211 is a wireless communication interface conforming to the standard of wireless LAN (IEEE 802.11 series). Also, it is assumed that the second communication unit 212 is a wireless communication interface conforming to Bluetooth Low Energy (BLE). Furthermore, it is assumed that the third communication unit 213 is a wired LAN (Ethernet) interface conforming to the standard of IEEE 802.3. Note that the first communication unit 211 to the third communication unit 213 may conform to other known wired or wireless communication standards. In addition, two or more of the first communication unit 211 to the third communication unit 213 may conform to the same communication standard.

Note that the second communication unit 212 can operate in a peripheral mode or a central mode in the BLE standard. If the second communication unit 212 operates in the central mode, the smartphone 200 can connect to and communicate with an external device having a communication unit operating in the peripheral mode. In addition, in this embodiment, when communicating with the camera 100 through the second communication unit 212, the smartphone 200 functions as a server that receives image data from the camera 100 that functions as a client. Note that it is assumed that information about paired external devices is stored in the non-volatile memory 203.

A public network connection unit 202 is a communication interface with a mobile communication network, and conforms to one or more communication standards (3G, 4G, 5G, etc.) established by, for example, the Third Generation Partnership Project (3GPP) (registered trademark).

A microphone 214 is used for making calls and inputting voice commands. The operation unit 205 includes the microphone 214 serving as an input device for voice commands.

A speaker 215 is used for calls and audio playback.

### System Configuration Diagram

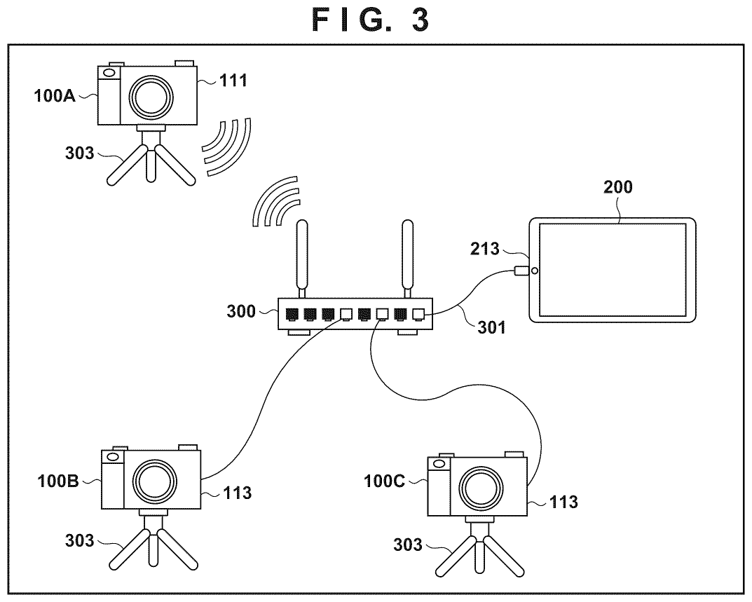

FIG. 3 is a schematic diagram of a remote image capture system in which a plurality of cameras 100A to 100C and an image capture control apparatus (smartphone 200) are communicably connected. The cameras 100A to 100C each have the same functional configuration as the camera 100 described with reference to FIGS. 1A to 1C. Note that in the following description, the cameras 100A to 100C will be collectively referred to as cameras 100.

Although FIG. 3 does not show the subject being imaged, in actuality, the cameras 100 can be installed to capture an image of a specific subject from different positions. Although three cameras 100 are shown in FIG. 3, more cameras 100 may also be included.

The camera 100 is mounted on a tripod 303 and is installed at a predetermined image capture position and image capture direction. Note that the image capture direction of the camera 100 may also be remotely controllable. For example, the camera 100 may be mounted on a camera platform that allows remote panning and tilting. Alternatively, the panning and tilting of a lens barrel of the image capture unit 102 of the camera 100 may be remotely controlled.

FIG. 3 shows a state in which the cameras 100A to 100C and the smartphone 200 are connected to the same local network via a network device (wireless LAN router) 300. The cameras 100B and 100C are connected by wire to the network device 300 via the third communication unit 113. In addition, the camera 100A is wirelessly connected to the network device 300 via the first communication unit 111. The smartphone 200 is connected by wire to the network device 300 via the third communication unit 213. The communication methods between the smartphone 200 and the camera 100 shown in FIG. 3 are merely examples, and other communication methods may also be used.

For example, the camera 100 and the smartphone 200 may communicate directly without using the network device 300. In addition, one camera 100 may function as the network device 300. Furthermore, it is not necessary for all of the cameras 100 and the smartphone 200 to be connected to a common network.

When the smartphone 200 is capable of communicating with each of the plurality of cameras 100, the smartphone 200 can control the operation of each of the cameras 100. For example, the smartphone 200 can obtain information from the camera 100 or cause the camera 100 to perform an operation by transmitting a command to the camera 100 that is the target.

### Example of Remote Image Capture

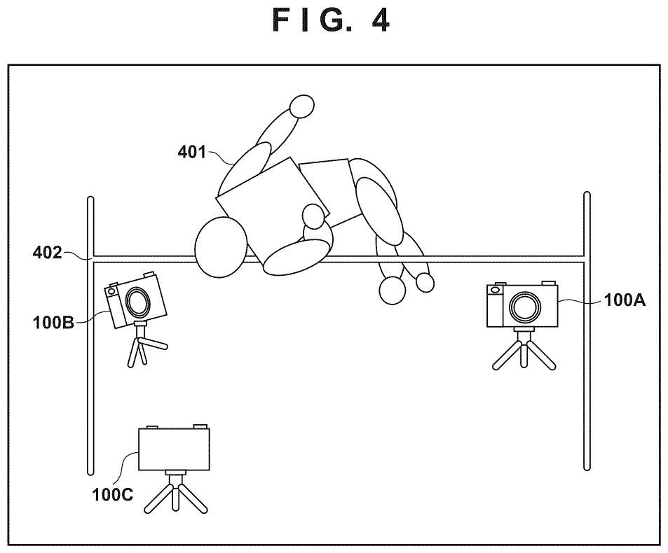

FIG. 4 is a diagram showing an example of the arrangement of the cameras 100A to 100C when remotely capturing an image of a high jump scene using the remote image capture system shown in FIG. 3. The cameras 100A to 100C are installed to simultaneously capture, from various angles, an image of a scene in which a subject 401 jumps over a bar 402. For example, the camera 100 for capturing the run-up scene may be installed separately.

When simultaneously capturing images using the plurality of cameras 100, the same exposure conditions may be set for the plurality of cameras 100 in order to unify the brightness of the images and the degree of subject blur. In addition, in order to simplify the effort required to set exposure conditions, the same exposure conditions may be set for the plurality of cameras 100 and then fine-tuned for each camera 100. Here, the exposure condition may be a combination of a plurality of parameters including aperture value, shutter speed, and sensitivity.

### Example of Screen of Remote Image Capture Application

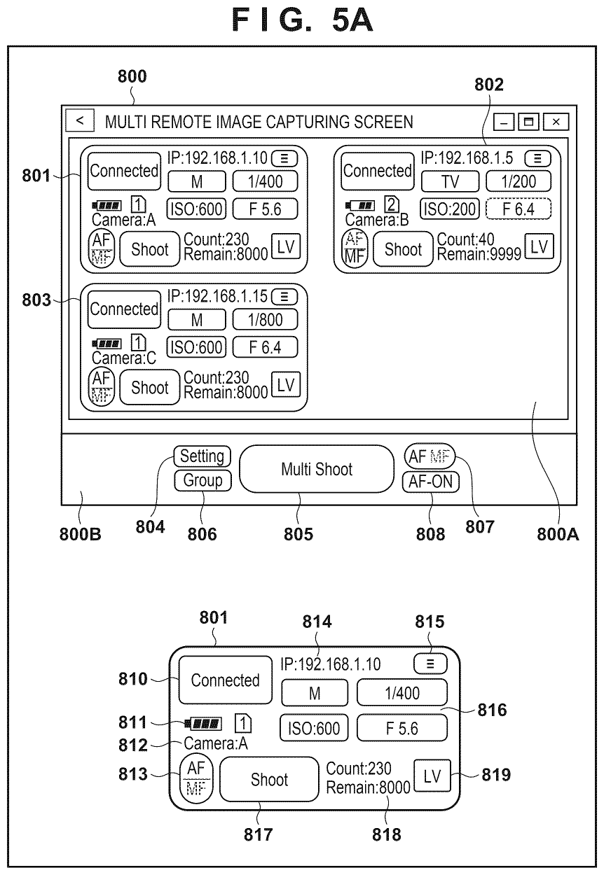

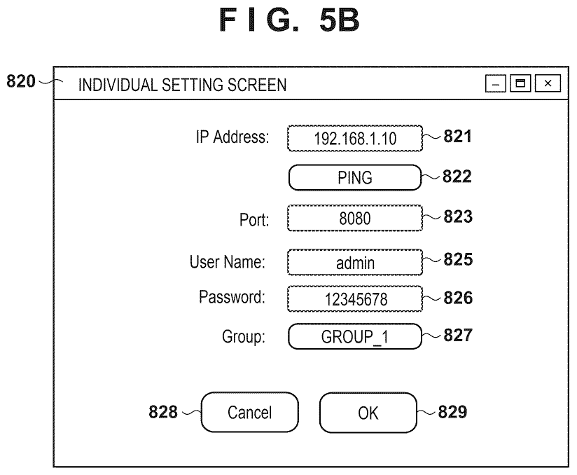

FIGS. 5A and 5B show examples of screens provided by a remote image capture application executed on the smartphone 200. Here, it is assumed that the three cameras 100A to 100C are in a state in which they can communicate with the smartphone 200, as shown in FIGS. 3 and 4.

FIG. 5A shows an example of a main screen 800 that is displayed when the remote image capture application is started up. The upper diagram shows the entire main screen 800, and the lower diagram shows an enlarged portion of the main screen 800.

The main screen 800 has an individual operation UI region 800A and a collective operation UI region 800B. The individual operation UI region 800A displays individual operation user interfaces (UIs) 801 to 803, which are user interfaces for individually and remotely operating cameras that are in a communicable (controllable) state. Also, the collective operation UI region 800B displays a UI for collectively controlling cameras that are in a communicable state.

The number of individual operation UIs that are displayed in the individual operation UI region 800A is the same as the number of cameras that are in a communicable state. In FIG. 3, three individual operation UIs 801 to 803 respectively corresponding to the cameras 100A (Camera A) to 100C (Camera C) are displayed in the individual operation UI region 800A. If there are five or more cameras in a communicable state, the individual operation UI region 800A is displayed in a scrollable manner, and the user can scroll the individual operation UI region 800A such that the individual operation UI corresponding to the desired camera is displayed.

When the control unit 201 of the smartphone 200 starts executing the remote image capture application, the control unit 201 detects cameras that are in a communicable state via the first communication unit 211 to the third communication unit 213. Then, the control unit 201 uses information about each of the cameras that are in a communicable state to display the corresponding individual operation UI in the individual operation UI region 800A. When a specific event occurs or in response to a user instruction, the control unit 201 executes processing for detecting cameras that are in a communicable state, and updates the display of the individual operation UI region 800A as needed.

### Individual Operation UI

FIG. 5A is an enlarged view of the individual operation UI 801. The individual operation UI 801 has a plurality of touch-operable buttons and information display items. A disconnection button 810 is a button for disconnecting the connection with the camera. A battery status display 811 shows the remaining battery power of the camera. The number of the recording medium being used is displayed to the right of the battery status display 811.

Identification information 812 is the name of the camera 100, and is associated with unique information such as the serial number of the camera 100, for example. The identification information 812 can be set by the user when registering the camera 100 in the smartphone 200 (remote image capture application), for example, during pairing or the like.

A focus type button 813 indicates whether the camera 100 is in an autofocus mode or a manual focus mode. Also, by operating the focus type button 813, a command to switch between the autofocus mode and the manual focus mode is transmitted to the corresponding camera 100.

A network address 814 displays the Internet Protocol (IP) address of the camera 100. Other addresses may also be displayed depending on the communication method.

A setting button 815 is a button for displaying an individual setting screen for the camera (FIG. 5B), which will be described later.

An image capture condition button 816 is a button for changing the exposure mode and the parameter values that determine the image capture conditions. Here, separate buttons are provided for exposure modes and parameters (shutter speed, aperture value, and sensitivity). As will be described later, a UI for setting a value is displayed according to the button that is operated.

When an image capture button 817 is operated, a command to instruct the corresponding camera 100 to perform image capture is transmitted. Here, it is assumed that a command to capture a still image is sent by operating the image capture button 817.

A counter 818 indicates the number of times image capture has been performed with the corresponding camera 100 and the number of images that can be captured based on the free space on the recording medium. The number of times image capture has been performed may be reset by a user instruction.

A live view (LV) button 819 is a button for checking a live view image of the corresponding camera 100 on the smartphone 200. When the live view button 819 is operated, a command instructing transfer of a live view image is transmitted to the corresponding camera 100. The transferred live view image is displayed in, for example, a separate window on the main screen 800.

The user can operate the individual operation UI 801 corresponding to the desired camera 100 to change settings or perform image capture remotely. Note that the form of the individual operation UI 801 shown in FIG. 5A is merely an example, and any other form may be adopted. Moreover, the individual operation UIs 802 and 803 have the same configuration as the individual operation UI 801, and therefore, description thereof will be omitted.

### Configuration of Collective Operation UI

A collective operation UI is a group of UIs for collectively transmitting a command to a plurality of cameras 100. The targets of the collective operation may be, for example, all cameras 100 for which an individual operation UI is displayed (which are currently in a communicable state), or cameras 100 that belong to a pre-set group.

A collective setting button 804 is a button for collectively implementing the same setting for predetermined items. The details of the collective setting using the collective setting button 804 will be described later.

A collective image capture button 805 is a button for collectively transmitting a command to perform image capture to the cameras that are operation targets.

A group button 806 is a button for specifying a group of cameras 100 that are collective operation targets.

A focus type setting button 807 is a button for transmitting a command instructing switching between the autofocus mode and the manual focus mode to the cameras 100 that are the collective operation targets. The focus type setting button 807 also indicates whether the cameras 100 that are collective operation targets are in the autofocus mode or the manual focus mode.

An autofocus button 808 is a button for transmitting a command instructing execution of autofocus to the cameras 100 that are collective operation targets.

The user can operate the UI included in the collective operation UI to remotely and collectively change settings and execute image capture for a plurality of cameras 100. Note that the form of the collective operation UI shown in FIG. 5A is merely an example, and any other form may be adopted.

### Camera Individual Setting Screen

FIG. 5B shows an example of a camera individual setting screen 820 that the control unit 201 displays on the display unit 206 in response to operation of the setting button 815 of the individual operation UI. Here, as shown in FIG. 4, it is assumed that the camera 100 is connected to a local area network, and the camera 100 and the smartphone 200 perform communication conforming to the PTP-IP standard defined by the Camera and Imaging Products Association (CIPA). PTP-IP stands for Picture Transfer Protocol over TCP/IP networks. PTP-IP is a standard for executing PTP communication in local area networks that use communication conforming to the TCP/IP standard.

The individual setting screen 820 has an address setting region 821 for setting the IP address of the camera 100. Note that when a region for inputting numerical values or characters is selected on the individual setting screen 820, the control unit 201 displays a software keyboard screen provided by the OS, for example.

Also, a PING button 822 is a button for transmitting a PING command to the IP address set in the address setting region 821. When the PING button 822 is operated, the control unit 201 transmits a PING command via a communication unit connected to an external device or a network. The control unit 201 displays the response to the PING command in a separate window, for example.

A port number setting region 823 is a region for setting a port number used for communication with the camera 100.

A user name setting region 825 and a password setting region 826 are regions for setting a user name and a password to be used when requesting authentication from the camera 100.

A group setting button 827 is a button for setting a group to which the camera 100 is to be assigned. Here, group 1 is set as the default.

When a cancel button 828 is operated, the control unit 201 cancels the changes made on the individual setting screen 820 and closes the individual setting screen. On the other hand, when an OK button 829 is operated, the control unit 201 stores the setting details of the individual setting screen 820 at that time in association with the identification information about the corresponding camera 100 in the non-volatile memory 203, and then closes the individual setting screen.

Note that the number and types of items included in the individual setting screen 820 are not limited to those shown in FIG. 5B. Other items may also be included, and some items may not be included. For example, the items on the individual setting screen for the same camera may differ depending on the communication method.

### Operation of Smartphone 200

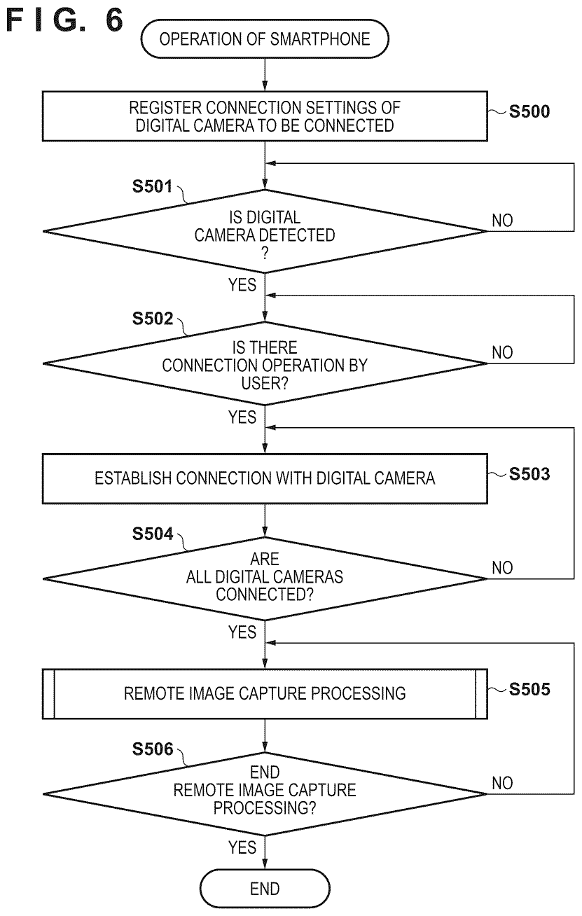

Next, the operation of the smartphone 200 serving as the image capture control apparatus in the above-described remote image capture system will be further described with reference to the flowcharts shown in FIGS. 6 to 11. The operation of the smartphone 200 described below is realized by the control unit 201 executing a remote image capture application.

The operation shown in the flowchart of FIG. 6 starts when the remote image capture application is started up on the smartphone 200 or becomes active.

In step S500, the control unit 201 executes registration processing for the camera 100 that is the operation target. The registration processing may differ depending on the method of communication with the camera 100. For example, when communication is performed via the second communication unit 212, the control unit 201 executes a pairing operation conforming to the Bluetooth standard. Also, when communicating via the third communication unit 213, the control unit 201 displays, on the display unit 206, a screen (e.g., individual setting screen 820) for the user to input information necessary for communication, such as an IP address, a user name, and a password. When communicating via the first communication unit 211, the control unit 201 displays, on the display unit 206, a screen for the user to input information necessary for communication via a wireless LAN, such as an access point and a password. Note that the registration processing of the camera 100 may also be performed by any other known method.

When the control unit 201 confirms that communication with the camera 100 is possible, it acquires, for example, unique information (identification information) from the camera 100 and stores it in the non-volatile memory 203 in association with the information necessary for communication.

Note that step S500 does not need to be executed every time the remote image capture application is started up, but only when necessary. For example, step S500 may be executed when there are no registered cameras, when there are no cameras or only one camera that can communicate, or when an instruction to add a camera is given by the user.

In step S501, the control unit 201 executes processing for detecting the camera 100 whose information is registered in the non-volatile memory 203. Then, the control unit 201 determines whether or not one or more cameras 100 have been detected. If it is determined that one or more cameras 100 have been detected, the control unit 201 executes step S502, and if not, the control unit 201 repeats the execution of step S501.

In step S502, the control unit 201 displays, on the display unit 206, a screen that asks the user whether or not to establish a connection with the camera 100 detected in step S501. The control unit 201 determines whether or not a connection operation has been detected through the screen. If it is determined that a connection operation has been detected, the control unit 201 executes step S503, and if it is not determined that a connection operation has been detected, the control unit 201 repeats the execution of step S502. Note that the screen may also include a list of the cameras 100 detected in step S501.

In steps S503 and S504, the control unit 201 establishes a connection with each of the cameras 100 detected in step S501. Thereafter, the control unit 201 executes step S505. Note that the user may individually perform a connection operation for each of the cameras 100 detected in step S501. In this case, the user can remotely operate only a specific camera 100 from among the detected cameras 100.

In step S505, the control unit 201 executes remote image capture processing, which will be described later. Thereafter, the control unit 201 executes step S506.

In step S506, the control unit 201 determines whether or not to end the remote image capture processing. If it is determined that the remote image capture processing is to be ended, the control unit 201 ends the operation shown in the flowchart of FIG. 6, and if it is not determined that the processing is to be ended, the control unit 201 executes step S505 again. The control unit 201 can determine that the remote image capture processing is to be ended, for example, when the user explicitly instructs the end of the remote image capture processing, or when an operation to end or inactivate the remote image capture application is detected. The control unit 201 may determine the end of the remote image capture processing based on another condition.

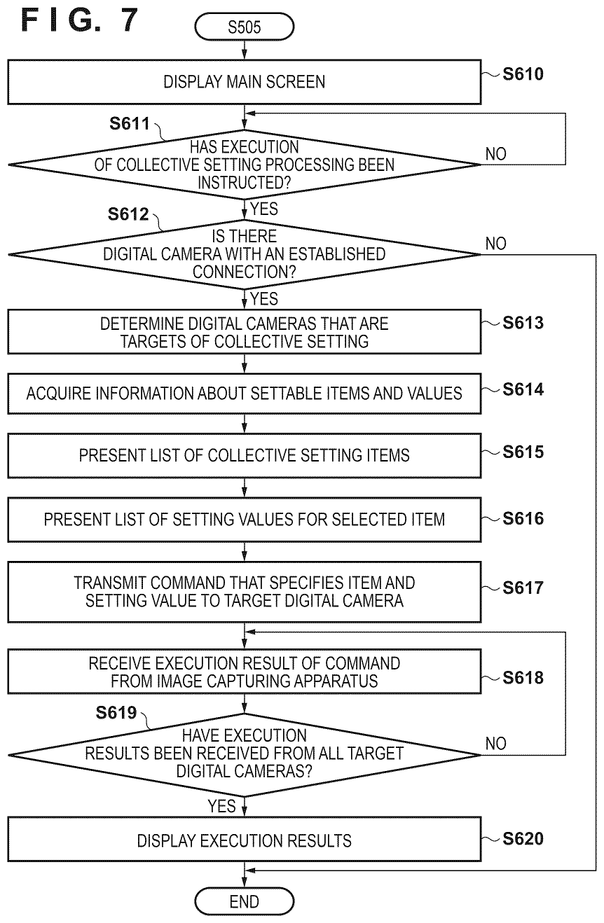

Next, the remote image capture processing in step S505 will be described in detail with reference to the flowchart shown in FIG. 7.

In step S610, the control unit 201 displays the main screen 800 shown in FIG. 5A on the display unit 206. The control unit 201 generates the main screen 800 including an individual operation UI for each of the cameras 100 with which a connection was established in step S503, and displays the main screen 800 on the display unit 206. When generating an individual operation UI, the control unit 201 can refer to the non-volatile memory 203 or acquire information through communication as necessary. When the main screen 800 is displayed, the control unit 201 executes step S611.

In step S611, the control unit 201 determines whether or not execution of collective setting processing for a plurality of cameras 100 has been instructed. For example, when the control unit 201 detects operation of the collective setting button 804, the control unit 201 can determine that execution of collective setting processing has been instructed. If it is determined that execution of collective setting processing has been instructed, the control unit 201 executes step S612, and if not, the control unit 201 repeats the execution of step S611.

Note that since the description here focuses on the collective setting operation, a description of the operation of the control unit 201 when operation of a button other than the collective setting button 804 included in the main screen 800 is detected will be omitted. However, as described above with reference to FIGS. 5A and 5B, when operation of a button other than the collective setting button 804 is detected, the control unit 201 executes an operation corresponding to the button whose operation is detected. For example, when operation of the collective image capture button 805 is detected, the control unit 201 collectively transmits commands instructing image capture to the cameras that are operation targets. Thereafter, the control unit 201 waits for detection of an operation on the UI included in the main screen 800 in step S611.

In step S612, the control unit 201 determines whether or not there is a camera 100 with an established connection. If there has been no change in the connection state after the connection is established in steps S503 and S504, there will be a camera 100 with an established connection. If it is determined that there is a camera 100 with an established connection, the control unit 201 executes step S613, and if not, the control unit 201 ends the remote image capture processing and executes step S506.

In step S613, the control unit 201 determines the cameras 100 that are the targets of the collective setting processing from among the cameras 100 with established connections. The control unit 201 can determine the cameras belonging to the group specified by operating the group button 806 as the targets of the collective setting processing. Note that it is assumed that the group that is the target of the collective setting processing is stored in the non-volatile memory 203. The group that is the target of the collective setting processing is set to group 1 by default. Group 1 is the group that the camera belongs to by default. Accordingly, if the default setting has not been changed, all cameras 100 with established connections are determined as targets of the collective setting processing.

On the other hand, by allocating a specific number of cameras to a group other than group 1 (e.g., group 2) and specifying group 2 with the group button 806, it is possible to limit the cameras that are the targets of the collective setting processing. For example, cameras 100 of the same model may be grouped together, or cameras 100 may be grouped together according to the geographical region in which they are installed.

In step S614, the control unit 201 transmits, via the third communication unit 213, a command requesting settable items and settable values for each item to each of the cameras 100 that are the targets of the collective setting processing determined in step S613. Then, the control unit 201 stores the information transmitted from each camera 100 in response to the command in, for example, the non-volatile memory 203. Thereafter, the control unit 201 executes step S615.

In step S615, the control unit 201 determines the items subject to collective setting from the information acquired in step S614. Here, as an example, the control unit 201 determines items that can be set for two or more cameras as items subject to collective setting. Note that items that are settable for one or more cameras or for all cameras may be determined as items subject to collective setting.

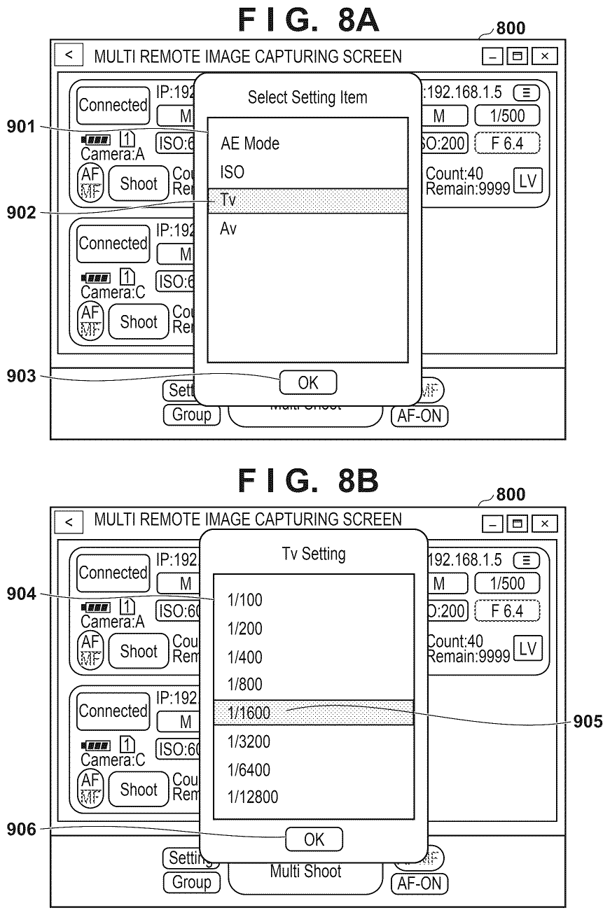

Then, the control unit 201 displays a list of items subject to collective setting on the display unit 206 in a selectable form. FIG. 8A shows an example in which a list 901 of items subject to collective setting are displayed in a pop-up window. Here, it is assumed that the items subject to collective setting are the exposure mode (AE Mode), the image capture sensitivity (ISO), the shutter speed (Tv), and the aperture value (Av).

When a selection operation (e.g., a tap) of an item is detected, the control unit 201 highlights the item to indicate that it is being selected. FIG. 8A shows a state in which a shutter speed (Tv) 902 is selected. In addition, when the control unit 201 detects operation of an OK button 903 of the pop-up window, the control unit 201 ends the display of the pop-up window and executes step S616.

In step S616, the control unit 201 acquires the item that was selected in the list 901 when the OK button 903 was operated, and stores the item in the work memory 204, for example. Then, the control unit 201 displays a list of values that can be set for the selected item on the display unit 206 in a selectable form. Here, it is assumed that the control unit 201 displays a list of values that can be set for two or more cameras 100 that are the targets of the collective setting processing, based on the information acquired in step S614. However, a list of values that are settable for one or more cameras or all cameras may also be displayed.

FIG. 8B is an example of a list 904 of settable values that is displayed if the shutter speed (Tv) 902 was selected when the OK button 903 was operated. The list 904 is displayed in a pop-up window similarly to the list 901 of items subject to collective setting.

When a selection operation (e.g., a tap) of an item is detected, the control unit 201 highlights the item to indicate that it is being selected. FIG. 8B shows a state in which a shutter speed 905 of 1/1600 seconds is selected. When the control unit 201 detects operation of the OK button 906 of the pop-up window, the control unit 201 ends the display of the pop-up window and executes step S617.

Note that the settable values are not necessarily the same for all of the cameras 100 that are the targets of the collective setting processing. For this reason, in the list of settable values, it is possible to indicate whether or not each individual value can be set for all of the cameras 100 that are the targets of the collective setting processing.

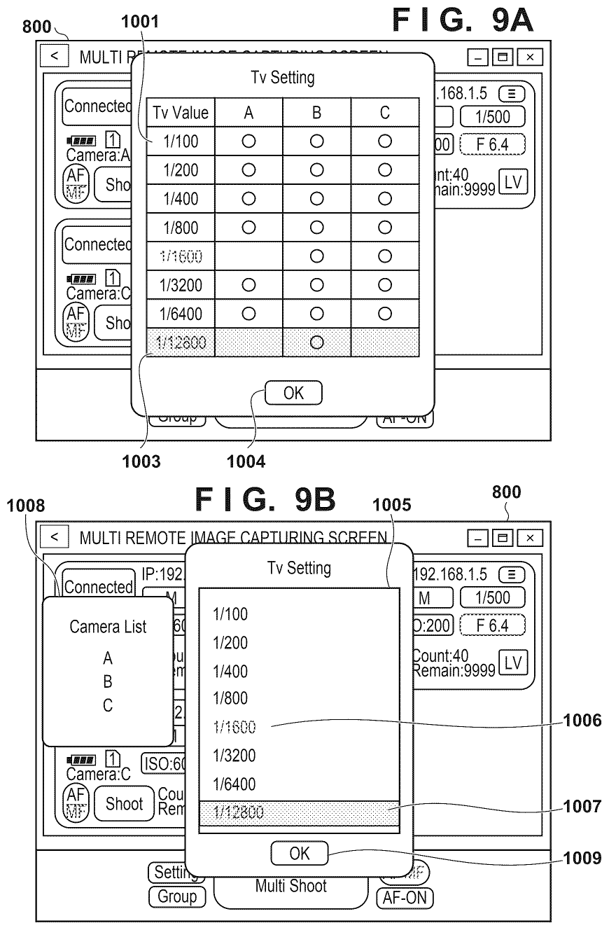

FIG. 9A is an example of a list showing whether or not each value can be set for each camera. For each of cameras A, B, and C that are targets of the collective setting processing, values that can be set are indicated by a circle, and values that cannot be set are indicated by a blank space. Furthermore, values that cannot be set for one or more cameras have a different display form than values that can be set for all cameras. In FIG. 9A, the shutter speeds of 1/1600 seconds and 1/12800 seconds are grayed out as an example because they can only be set for some cameras, but another display form may also be used.

When a value selection operation (e.g., a tap) is detected, the control unit 201 highlights the entire row of values to indicate that they are being selected. FIG. 9A shows a state in which a shutter speed 1003 of 1/12800 seconds is selected. When the control unit 201 detects an operation on the OK button 1004 of the pop-up window, it ends the display of the pop-up window and executes step S617.

FIG. 9B shows an example in which a list 1008 of cameras that are targets of the collective setting processing is displayed in addition to a list 1005 that is similar to the list 904 shown in FIG. 8B. The list 1005 is the same as the list 904, except that values that cannot be set for one or more cameras in the list 1008 are in a different display form than values that can be set for all cameras. A camera list 1008 is a list of camera names (here, A, B, C). The control unit 201 uses different display forms for the names of cameras for which the value selected in the value list 1005 (here, 1/12800 seconds) can be set, and the names of cameras for which the value cannot be set. In FIG. 9B, the names of cameras for which the selected value cannot be set are grayed out, but another display form may also be used. However, it is assumed that the display form of a value that cannot be set for one or more cameras matches the display form of the name of the camera for which the selected value cannot be set.

Note that FIG. 9B shows an example in which the value list 1005 and the camera list 1008 are displayed in separate windows. However, both lists may also be displayed in one window.

When a value selection operation (e.g., a tap) is detected, the control unit 201 highlights the entire row of values to indicate that they are being selected. FIG. 9B shows a state in which a shutter speed 1007 of 1/12800 seconds is selected. When the control unit 201 detects operation of the OK button 1009 of the pop-up window, the control unit 201 ends the display of the pop-up window and executes step S617.

Note that in the list 901 of setting items shown in FIG. 8A as well, the display form of an item that cannot be set for one or more cameras may be different from the display form of an item that can be set for all cameras. The setting items may also be displayed in a form similar to the example of FIG. 9A or FIG. 9B. Specifically, it is possible to use a form in which selection items are listed instead of the shutter speeds in FIGS. 9A and 9B.

In step S617, the control unit 201 acquires the value selected in the value list 904, 1001, or 1005 when the OK button 906, 1004, or 1009 in the pop-up window displaying the list of settable values is operated. The control unit 201 stores the value in the work memory 204, for example.

The control unit 201 generates a setting command that specifies the details to be set (the item acquired in step S616 and the value acquired in step S617). Then, the control unit 201 transmits the generated setting command to all cameras that are targets of collective setting. Note that the control unit 201 may transmit a setting command to all cameras regardless of whether or not the value can be set. Alternatively, the control unit 201 may transmit a setting command to a camera for which the value can be set, and may not transmit a setting command to a camera for which the value cannot be set.

In step S618, the control unit 201 receives the setting result from the camera that transmitted the setting command. This setting result is transmitted by the camera in step S708, which will be described later. The setting result indicates whether or not the setting according to the setting command transmitted in step S617 was successful.

In step S619, the control unit 201 determines whether or not the execution results of the command have been received from all cameras to which the setting command was transmitted in step S617, and if it is determined that the execution results have been received, the control unit 201 executes step S620, and if not, the control unit 201 executes step S618 again.

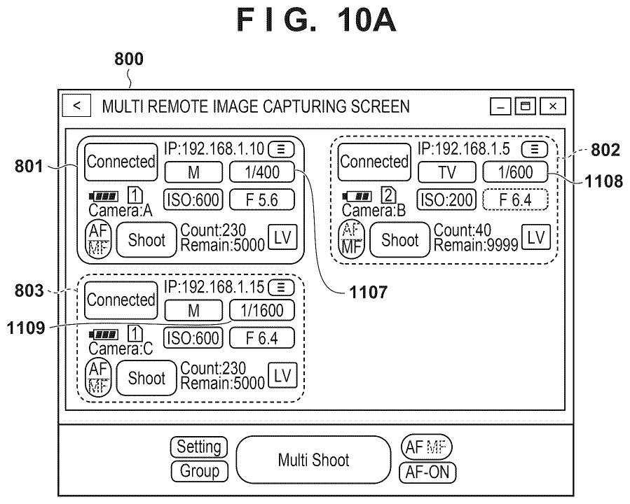

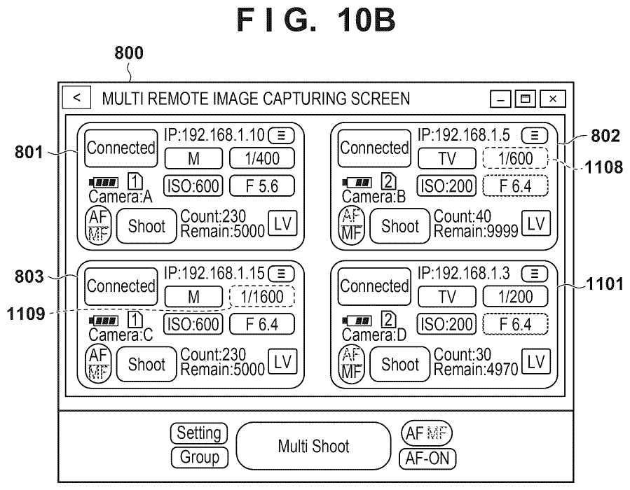

In step S620, the control unit 201 notifies the execution result received in step S619. Here, the control unit 201 notifies of the execution result by displaying the execution result on the display unit 206. There is no particular limitation on the display method for notifying of the execution results, as long as the success or failure of the execution is indicated at least for each camera. Here, an example of displaying the execution results using the main screen 800 will be described with reference to FIGS. 10A and 10B. Here, it is assumed that a command to set the shutter speed (Tv) to 1/1600 seconds has been transmitted to the cameras A, B, and C, which are displaying individual operation UIs 801 to 803 on the main screen 800 shown in FIG. 5A.

As shown in FIG. 9A, a shutter speed of 1/1600 seconds can be set for cameras B and C, but not for camera A. For this reason, the control unit 201 receives execution results indicating successful setting from cameras B and C, and execution results indicating unsuccessful setting from camera A. Note that even if a setting command is not transmitted to camera A because a shutter speed of 1/1600 seconds cannot be set for camera A, the control unit 201 treats this as having received an execution result of success or failure from camera A.

FIG. 10A shows an example of notification of the execution result through the display form. When a setting command for an item displayed in the individual operation UI is transmitted, the control unit 201 updates the display of the item in the individual operation UI corresponding to the camera that transmitted the execution result indicating successful setting to a new setting value. Accordingly, the display of the shutter speed buttons 1108 and 1109 in the individual operation UI 802 corresponding to camera B and the individual operation UI 803 corresponding to camera C is updated to 1/1600. On the other hand, the shutter speed button 1107 in the individual operation UI 801 corresponding to camera A remains displayed as 1/400.

Furthermore, the control unit 201 can perform notification of the camera whose settings have been successfully changed by changing, for example, for a certain period of time, the display form of the frames of the individual operation UIs 802 and 803 corresponding to cameras B and C for which the setting command was executed successfully and whose settings have been changed. FIG. 10A shows an example in which the frames of the individual operation UIs 802 and 803 are changed from solid lines to thicker dotted lines. Other display forms may be employed, such as a blinking frame or changing color. Note that the main screen 800 can be operated even while the display form of the frame is changing.

Notification of the execution result of the setting command may be performed using a method other than changing the display form of the frame of the individual operation UI. For example, the background color of the individual operation UI corresponding to the camera that has successfully executed the setting command may be changed. Alternatively, as shown in FIG. 10B, the UI corresponding to an item that is included in the individual operation UI and whose setting has been successfully changed may be highlighted. Here, the shutter speed buttons 1108 and 1109 included in the individual operation UIs 802 and 803 for cameras B and C, whose shutter speeds have been changed, are highlighted by being surrounded by a thick dotted line for a certain period of time. Highlighting may also be performed in other ways, such as by changing the UI display color.

Note that the main screen 800 shown in FIG. 10B displays individual operation UIs 801 to 803 corresponding to cameras A, B, and C that were the targets of the collective setting processing, as well as an individual operation UI 1101 corresponding to a camera D, which is not the target of the collective setting processing. The control unit 201 may change the display form of the corresponding individual operation UI such that it is possible to distinguish between cameras that are the targets of the collective setting processing and cameras that are not the targets. FIG. 10B shows an example in which the frames of the individual operation UIs 801 to 803 corresponding to the cameras that are the targets of the collective setting processing are displayed thicker than the frame of the individual operation UI 1101 corresponding to the camera that is not the target of the collective setting processing. Such a display form may be executed continuously as long as the targets of the collective setting processing remain unchanged, or may be executed for a certain period of time during which the execution results of the setting command are displayed.

In addition, the display form shown in FIG. 10A and the display form shown in FIG. 10B may be combined. For example, in FIG. 10B, the frames of the individual operation UIs 802 and 803 corresponding to cameras B and C may be displayed as dotted lines for a certain period of time to display the execution results of the command. Alternatively, in FIG. 10A, the shutter speed buttons 1108 and 1109 included in the individual operation UIs 802 and 803 corresponding to cameras B and C may be highlighted for a certain period of time.

Upon displaying the execution results of the setting command for a certain period of time, the control unit 201 ends the operation shown in the flowchart of FIG. 7 and executes step S506 (FIG. 6).

Note that in order to facilitate description and understanding, the setting is performed for each item. However, a configuration is also possible in which setting values are accepted for a plurality of items and settings for a plurality of items are executed with one setting command.

### Operation of Digital Camera 100

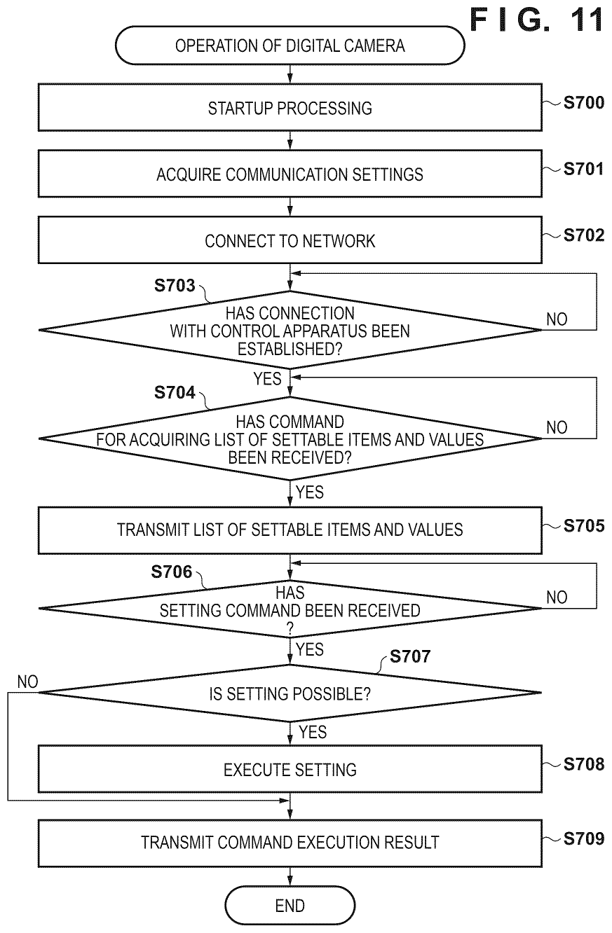

Next, operation of the digital camera 100 included in the remote image capture system of this embodiment will be described with reference to the flowchart shown in FIG. 11. The operation shown in FIG. 11 starts when the digital camera 100 is set to an image capture position and is powered on.

In step S700, the control unit 101 executes startup processing in response to an instruction to power on, for example, through operation of a power switch.

In step S701, the control unit 101 acquires communication settings related to the third communication unit 113 from the non-volatile memory 103. For example, the control unit 101 acquires, as communication settings, an IP address, a port number, and a user name and password used to connect to the network.

In step S702, the control unit 101 connects to the network via the third communication unit 113 using the communication settings acquired in step S701. Note that the description here is premised on communication with the smartphone 200 being performed using the third communication unit 113. However, if the communication unit to be used for communication with the smartphone 200 is not specified, the control unit 101 may execute the operations of step S701 and S702 for each of the first communication unit 111 to the third communication unit 113 in accordance with the standard to which they conform.

In step S703, the control unit 101 determines whether or not a connection request has been received from the smartphone 200, and if it is determined that a connection request has been received, the control unit 101 executes step S704, and if not, the control unit 101 repeats the execution of step S703.

In step S704, the control unit 101 determines whether or not a command (transmission request) to acquire the settable items and values has been received from the smartphone 200, and if it is determined that the command has been received, the control unit 101 executes step S705, and if not, the control unit 101 repeats the execution of step S704.

In step S705, the control unit 101 transmits items that can be set from the smartphone 200 and values that can be set for the items to the smartphone 200, for example, in a list format. Information about the settable items and the values that can be set for the items is stored in advance in, for example, the non-volatile memory 103. Note that at least one of the settable items and the settable values for the items may change depending on the state of the camera 100.

In step S706, it is determined whether or not a setting command has been received from the smartphone 200, and if it is determined that a setting command has been received, step S707 is executed, and if not, execution of step S706 is repeated.

Note that since the description here focuses on the collective setting operation, description of the operation of the control unit 101 when a command other than the setting command is received from the smartphone 200 is omitted. However, when a command other than the setting command is received, the command being transmitted from the smartphone 200 in response to the various UI operations described above with reference to FIGS. 5A and 5B, the control unit 101 executes an operation in accordance with the received command. For example, when a command to execute image capture is received, the control unit 101 executes capture and recording of a still image. Thereafter, the control unit 101 determines whether or not a setting command has been received in step S706.

In step S707, the control unit 101 extracts the item and the setting value specified in the setting command received from the smartphone 200. Then, the control unit 101 determines whether or not the setting according to the setting command is possible. If it is determined that the setting according to the setting command is possible, the control unit 101 executes step S708, and if not, the control unit 101 executes step S709.

In step S708, the control unit 101 executes the setting in accordance with the setting command. Thereafter, the control unit 101 executes step S709.

Note that if it is determined in step S707 that the setting in accordance with the setting command is possible because the item specified in the setting command can be set but the value cannot be set, the control unit 101 may set the value closest to the specified value in step S708. Furthermore, in order to suppress changes in the amount of exposure, the control unit 101 may change the setting values for items of the shooting conditions that are not specified in the setting command.

For example, if a shutter speed of 1/1600 seconds is specified in the setting command, but the closest settable shutter speed is 1/800 seconds, the control unit 101 sets the shutter speed to 1/800 seconds. Then, the control unit 101 can set the image capture sensitivity to half of the current setting value, for example, to make the exposure amount equal to that in the case where 1/1600 seconds is set.

In step S709, the control unit 101 transmits the execution result of the setting command to the smartphone 200, and ends the operation shown in FIG. 11. Note that the control unit 101 may repeat execution of the processing from step S706 until the connection is disconnected.

Note that if the settings cannot be executed as specified in the setting command, the execution is treated as a failure even if the settings are changed to settings close to the specified settings. However, if the settings are changed to settings close to the specified settings, the settings resulting from the change may be included in the execution results. This makes it possible to update the display of the individual operation UI on the smartphone 200 to the current setting values.

As described above, according to this embodiment, it is possible to collectively execute settings for a plurality of image capture apparatuses from an image capture control apparatus that can remotely operate the image capture apparatuses. For this reason, there is no need to repeatedly perform settings for each individual image capture apparatus, whereby usability can be significantly improved. In addition, the user can ascertain whether or not the value to be set can be set for all of the image capture apparatuses before transmitting a setting command. This allows the user to select values that can be set for a plurality of image capture apparatuses as needed, or to ascertain in advance the image capture apparatuses for which desired value cannot be set, whereby it is possible to assist in executing efficient settings.

According to an embodiment of the present disclosure, it is possible to provide an image capture control device and an image capture control method that improve the ease of use in configuring a setting of image capture apparatuses to be controlled.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image capture control apparatus capable of remotely operating an image capture apparatus, comprising:
one or more processors that execute a program stored in a memory and thereby cause the image capture control apparatus to:
generate a setting command specifying a detail to be set in common for a plurality of image capture apparatuses; and
transmit the setting command to the plurality of image capture apparatuses.

2. The image capture control apparatus according to claim 1, wherein the plurality of image capture apparatuses are part of a plurality of image capture apparatuses that are in a state of being capable of communication with the image capture control apparatus.

3. The image capture control apparatus according to claim 1, the one or more processors further cause the image capture control apparatus to:
acquire information about settable items and values from a plurality of image capture apparatuses that are in a state of being capable of communication; and
display a screen for selecting the detail on a display device, based on the acquired information.

4. The image capture control apparatus according to claim 3, wherein on the screen for selecting the detail, a display form of a detail that can be set for all of the plurality of image capture apparatuses that are in the state of being capable of communication is different from a display form of a detail that can be set for only a part of the plurality of image capture apparatuses that are in the state of being capable of communication.

5. The image capture control apparatus according to claim 3, wherein
the detail includes a value to be set, and
on the screen for selecting the detail, a value that can be set is displayed for each of the plurality of image capture apparatuses that are in the state of being capable of communication.

6. The image capture control apparatus according to claim 3, wherein
the detail includes a value to be set, and
when a specific value is selected on the screen for selecting the detail, an image capture apparatus for which the specific value can be set among the plurality of image capture apparatuses that are in the state of being capable of communication is indicated.

7. The image capture control apparatus according to claim 6, wherein the one or more processors cause the image capture control apparatus to:
display a list of the plurality of image capture apparatuses that are in the state of being capable of communication, together with the screen for selecting the detail, on the display device; and
when the specific value is selected on the screen for selecting the detail, make a display form of the image capture apparatus for which the specific value can be set different from a display form of an image capture apparatus for which the specific value cannot be set in the list.

8. The image capture control apparatus according to claim 3, wherein
the detail includes an item to be set,
the one or more processors cause the image capture control apparatus to:
display, on the display device, a screen for selecting an item that can be set for two or more image capture apparatuses, based on the acquired information, and
display, on the display device, a screen for selecting a value that can be set for one or more image capture apparatuses, with respect to the item selected on the screen for selecting the item.

9. The image capture control apparatus according to claim 3, the one or more processors further cause the image capture control apparatus to
receive an execution result of execution of the setting command from each of the plurality of image capture apparatuses to which the setting command was transmitted; and
notify of the execution results.

10. The image capture control apparatus according to claim 9, wherein the one or more processors cause the image capture control apparatus to:
display, on the display device, a screen including a user interface for individually and remotely operating each of the plurality of image capture apparatuses that are in a state of being capable of communication with the image capture control apparatus; and
for each of the plurality of image capture apparatuses to which the setting command was transmitted, notify of the execution result received from the image capture apparatus using a display form of the user interface corresponding to the image capture apparatus.

11. An image capture control method to be executed by an image capture control apparatus capable of remotely operating an image capture apparatus, comprising:
generating a setting command specifying a detail to be set in common for a plurality of image capture apparatuses; and
transmitting the setting command to the plurality of image capture apparatuses.

12. A non-transitory computer-readable medium storing a program that, when executed by a computer in an image capture control apparatus capable of remotely operating an image capture apparatus, causes the computer to perform the image capture control method comprising:
generating a setting command specifying a detail to be set in common for a plurality of image capture apparatuses; and
transmitting the setting command to the plurality of image capture apparatuses.

13. An image capture apparatus comprising:
one or more processors that execute a program stored in a memory and thereby cause the image capture apparatus to:
receive the setting command from the image capture control apparatus according to claim 1;
perform setting in accordance with the setting command;
if a value specified in the setting command cannot be set, set a value closest to the value; and
in order to suppress change in an amount of exposure caused by setting the closest value, change a setting for an item other than the item whose value is specified in the setting command.

14. A remote image capture system comprising:
an image capture control apparatus capable of remotely operating a plurality of image capture apparatuses; and
the plurality of the image capture apparatuses according, which are communicably connected to the image capture control apparatus,
wherein image capture control apparatus comprises one or more processors that execute a program stored in a memory and thereby cause the image capture control apparatus to:
generate a setting command specifying a detail to be set in common for a plurality of image capture apparatuses; and
transmit the setting command to the plurality of image capture apparatuses, and
wherein each of the plurality of image capture apparatus comprises one or more processors that execute a program stored in a memory and thereby cause the image capture apparatus to:
receive the setting command from the image capture control apparatus;
perform setting in accordance with the setting command;
if a value specified in the setting command cannot be set, set a value closest to the value; and
in order to suppress change in an amount of exposure caused by setting the closest value, change a setting for an item other than the item whose value is specified in the setting command.
